(19) United States
(12) Patent Application Publication
(10) Pub. No.: US 2007/0184848 A1
(43) Pub. Date: Aug. 9, 2007

(54) METHOD OF CONFIGURING A MOBILE TERMINAL AS A FUNCTION OF ITS GEOGRAHICAL POSITION AND TERMINAL FOR IMPLEMENTING THAT METHOD

(75) Inventors: Arnaud Gonguet, Paris (FR); Gerard Delegue, Cachan (FR); Stephane Betge-Brezetz, Paris (FR); Mohamed Adel Saidi, Antony (FR); Lionel Fournigault, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/612,207

(22) Filed: Dec. 18, 2006

(30) Foreign Application Priority Data
Dec. 21, 2005 (FR) 0513020

(51) Int. Cl. H04Q 7/20

(52) U.S. Cl. 455/456.1

(57) ABSTRACT

Method of configuring a mobile terminal (10) in a telecommunication network (20) as a function of the geographical position of that mobile terminal (10), the network (20) being divided into geographical cells each corresponding to the coverage of a base transceiver station adapted to exchange data with the mobile terminal (10) by radio, the position of that mobile terminal (10) being defined continuously while it is operating by location data that is a function of at least one base transceiver station, the method being of the type in which at least two separate geographical zones (Z1, Z2, Z3) are defined and at least one particular mode of operation of the mobile terminal (10) specific to each zone (Z1, Z2, Z3) is defined, in which method:
each zone (Z1, Z2, Z3) is geographically defined by location data that is a function of a set of at least two base transceiver stations contained in the zone (Z1, Z2, Z3),
the location data for the zones (Z1, Z2, Z3) is stored in a location data memory (30) in the network (20) and the particular modes of operation of the terminal (10) specific to those zones (Z1, Z2, Z3) are stored in a configuration memory (32,12),
the location data for the mobile terminal (10) is compared to the location data for the zones (Z1, Z2, Z3) to deduce in which zone (Z1, Z2, Z3) the mobile terminal (10) is situated,
the particular mode of operation specific to a zone (Z1, Z2, Z3) is applied as soon as the mobile terminal (10) is situated in that zone.

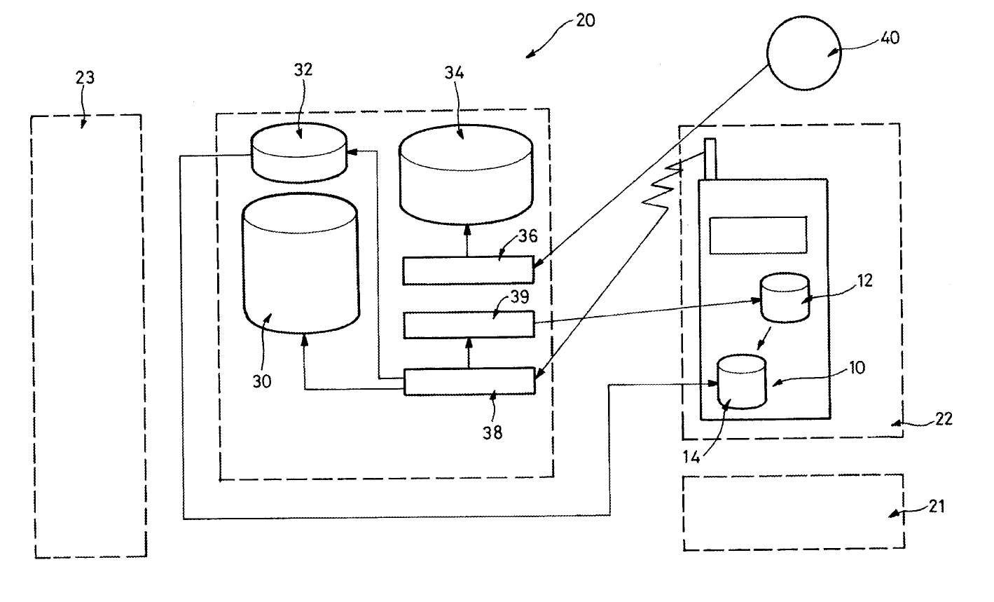

### CROSS-REFERENCE TO RELATED APPLICATIONS

This application is based on French Patent Application No. 0513020 filed on Dec. 21, 2005, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a method of configuring a mobile terminal as a function of its geographical position. The invention also relates to a terminal for implementing that method.

Configuring a mobile terminal as a function of its geographical position means particularizing the mode of operation of that terminal in accordance with a geographical criterion.

One, non-exclusive, field of application of the invention is that of mobile radiocommunication terminals operating in a radiocommunication system. The invention applies in particular, although not exclusively, to a system or network according to the following standards: GSM (Global System for Mobile communications), DCS (Digital Communication System), PCS or UMTS (Universal Mobile Telecommunication System), which terminal may further incorporate the 1.5 GHz GPS (Global Positioning System) or 2.5 GHz Wi-Fi (Wireless Fidelity) functions.

2. Description of the Prior Art

A GSM (Global System for Mobile communications) type cellular telecommunication network conventionally comprises a radio subsystem or base station subsystem (BSS) and a network subsystem (NSS).

The radio subsystem manages exchanges of data with the mobile terminals by radio and to this end comprises base transceiver stations (BTS) and base station controllers (BSC).

The network subsystem manages calls allowing for the mobility of the terminals and to this end comprises databases and cellular network switches or mobile switching centers (MSC).

The user of a terminal may wish to modify the configuration of his terminal according to his geographical position.

The problem is to detect the presence of the user of the terminal at a place where he wishes his terminal to have a particular configuration.

There is already known in the art, in particular from the document WO 02 071778, a method of managing the operation of a telecommunication network mobile terminal as a function of the geographical position of that terminal, the network being divided into geographical cells each corresponding to the coverage of a base transceiver station for exchanging data with the mobile terminal in service by radio, the position of that mobile terminal being defined continuously when it is operating by location data that is a function of a base transceiver station of the cell in which the terminal is situated.

Because of this each zone must be centered on a base transceiver station and each zone must cover all or part of the coverage cell of that base transceiver station.

This solution is therefore adapted to zones of small size and this causes a problem if the user requires configuration of his terminal for a larger zone, such as a town or a country.

An object of the invention is to provide a solution to these problems.

### SUMMARY OF THE INVENTION

To this end, the invention relates to a method of configuring a mobile terminal in a telecommunication network as a function of the geographical position of that mobile terminal, the network being divided into geographical cells each corresponding to the coverage of a base transceiver station adapted to exchange data with the mobile terminal by radio, the position of that mobile terminal being defined continuously while it is operating by location data that is a function of at least one base transceiver station, the method being of the type in which at least two separate geographical zones are defined and at least one particular mode of operation of the mobile terminal specific to each zone is defined, characterized in that:

each zone is geographically defined by location data that is a function of a set of at least two base transceiver stations contained in the zone,

the location data for the zones is stored in a location data memory in the network and the particular modes of operation of the terminal specific to those zones are stored in a configuration memory,

the location data for the mobile terminal is compared to the location data for the zones to deduce in which zone the mobile terminal is situated,

the particular mode of operation specific to a zone is applied as soon as the mobile terminal is situated in that zone.

In one particular embodiment the base transceiver stations contained in the zone have separate cellular coverages.

According to another aspect, the invention also relates to a terminal for implementing the method.

The terminal according to the invention may be a mobile telephone, a personal digital assistant (PDA) or a portable computer.

### BRIEF DESCRIPTION OF THE DRAWING

Other features and advantages of the invention will become apparent on reading the following description of one particular embodiment of the invention, provided by way of illustrative and nonlimiting example, and from the single FIGURE hereinafter.

### DETAILED DESCRIPTION OF THE PREFERRED EMBODIMENT

According to its geographical position, and therefore the zone Z1, Z2, Z3 in which it is situated, the user of a terminal 10 may necessitate automatic modification of the configuration of his terminal.

For example:

when at home Z1, certain incoming calls may not be accepted,

when at work Z2, the ringtone of the terminal 10 triggered by incoming calls may be different from the ringtone triggered when the user is in the zone Z1 of his home,

when abroad Z3, certain incoming calls may be rejected to avoid the user having to pay additional charges.

The zones Z1, Z2, Z3 are made up of at least two geographical cells each corresponding to the coverage of a base transceiver station.

These geographical cells may be separate, i.e. the geographical coverages of the base transceiver stations of these cells have no common geographical coordinates.

The user of the terminal 10 must subscribe to the geographical zone service from his operator 40.

The user of the terminal 10 is entered in a user database 34 by the operator 40 via a service activation server 36.

The various possible configurations of the terminal 10, i.e. its particular modes of operation specific to these zones Z1, Z2, Z3, may be stored in a configuration memory 32 in the network 20 and/or also in a configuration memory 12 in the terminal 10.

The configuration memory 32 in the network 20 may contain different configurations linked to billing or to the services accessible to the terminal 10.

The configuration memory 12 in the terminal 10 may contain different configurations linked to the ringtone of the terminal 10, to its clock, to be updated if the zone Z3 is abroad, or a screen background depending on the zone.

The terminal 10 therefore has access to the available geographical zones Z1, Z2, Z3 stored in a geographical zones memory 30 situated in the network 20.

The terminal 10 accesses its location data, i.e. the current geographical zone in which it is situated, by sending a request to the zone search server 38 which forwards the information to a change of zone notification server 39.

The location data for the mobile terminal 10 is compared to the data for the zones Z1, Z2, Z3 in the geographical zones memory 30 to deduce in which zone Z1, Z2, Z3 the mobile terminal 10 is situated.

The change of zone notification server 39 communicates with the geographical zones memory 30 and with one or the other of the two configuration memories 32, 12 of the network and of the terminal if appropriate.

The particular mode of operation specific to a zone Z1, Z2, Z3 is applied as soon as the mobile terminal 10 is situated in that zone, via a terminal configurator 14 situated in the terminal 10.

1. A method of configuring a mobile terminal in a telecommunication network as a function of the geographical position of that mobile terminal, the network being divided into geographical cells each corresponding to the coverage of a base transceiver station adapted to exchange data with the mobile terminal by radio, the position of that mobile terminal being defined continuously while it is operating by location data that is a function of at least one base transceiver station, the method being of the type in which at least two separate geographical zones are defined and at least one particular mode of operation of the mobile terminal specific to each zone is defined, wherein:
each zone is geographically defined by location data that is a function of a set of at least two base transceiver stations contained in the zone,
the location data for the zones is stored in a location data memory in the network and the particular modes of operation of the terminal specific to those zones are stored in a configuration memory,
the location data for the mobile terminal is compared to the location data for the zones to deduce in which zone the mobile terminal is situated,
the particular mode of operation specific to a zone is applied as soon as the mobile terminal is situated in that zone.

2. A method as claimed in claim 1, wherein the base transceiver stations contained in the zone have separate cellular coverages.

3. A method as claimed in claim 1, wherein the configuration memory of the particular modes of operation of the terminal specific to a zone is situated in the network.

4. A method as claimed in claim 1, wherein the configuration memory for the particular modes of operation of the terminal specific to a zone is situated in the terminal.

5. A terminal including means for executing the functions as claimed in claim 1.
